(19) United States
(12) Patent Application Publication
(10) Pub. No.: US 2023/0147224 A1
(43) Pub. Date: May 11, 2023

(54) ACKNOWLEDGEMENT/NEGATIVE-ACKNOWLEDGEMENT FEEDBACK ENHANCEMENTS

(71) Applicant: QUALCOMM Incorporated, San Diego, CA (US)

(72) Inventors: Gokul Sridharan, Sunnyvale, CA (US); Wei Yang, San Diego, CA (US); Seyedkianoush Hosseini, San Diego, CA (US); Peter Gaal, San Diego, CA (US)

(21) Appl. No.: 18/053,664

(22) Filed: Nov. 8, 2022

Related U.S. Application Data
(60) Provisional application No. 63/263,820, filed on Nov. 9, 2021.

(51) Int. Cl. H04L 1/18; H04L 5/00

(52) U.S. Cl. CPC H04L 1/1893; H04L 5/0055; H04L 5/0098; H04L 5/14

(57) ABSTRACT

A first apparatus may be a first network node or a component thereof, and may receive DCI from a second apparatus or a third apparatus. The second apparatus may be a second network node or a component thereof. The third apparatus may be a third network node or a component thereof. The DCI may include a scheduling grant for a first CC to be communicated over a channel and a HARQ feedback offset index value. The first apparatus may determine, based on the HARQ feedback offset index value, an offset value of a first plurality of offset values associated with a first CC. The first apparatus may transmit a HARQ feedback message in a slot of a second CC. The slot may be based on the determined offset value. The HARQ feedback message may indicate one of an ACK or NACK for data received from the second apparatus.

This application claims the benefit of and priority to U.S. Provisional Application No. 63/263,820, filed Nov. 9, 2021, the entire contents of which are hereby incorporated by reference in its entirety.

### TECHNICAL FIELD

The present disclosure generally relates to communication systems, and more particularly, acknowledgement (ACK)/negative ACK (NACK) feedback involving a plurality of component carriers.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects to provide a basic understanding of such aspects. This summary is not an extensive overview of all contemplated aspects, and neither identifies key or critical elements of any or all aspects nor delineates the scope of any or all aspects. Its purpose is to present some concepts of one or more aspects in a simplified form as a prelude to the more detailed description herein.

In one example, a first network node for performing wireless communication via a plurality of component carriers (CCs) includes a memory configured to store data received via wireless communication; and one or more processors implemented in circuitry and configured to: receive downlink control information (DCI) from a second network node, wherein the DCI includes a scheduling grant for a first component carrier (CC) of the plurality of CCs to be communicated over a channel and a hybrid automatic repeat request (HARQ) feedback offset index value; determine, based on the HARQ feedback offset index value, an offset value of a first plurality of offset values associated with the first CC; and transmit a HARQ feedback message in a slot of a second CC of the plurality of CCs, wherein the slot is based on the determined offset value, and wherein the HARQ feedback message indicates one of an acknowledgement (ACK) or a negative ACK (NACK) for data received from the second network node.

In another example, a first network node for performing wireless communication via a plurality of component carriers (CCs) includes a memory configured to store data received via wireless communication; and one or more processors implemented in circuitry and configured to: transmit downlink control information (DCI) to a second network node, wherein the DCI includes a scheduling grant for a first component carrier (CC) of the plurality of CCs to be communicated over a channel and a hybrid automatic repeat request (HARQ) feedback offset index value; and receive, from the second network node, a HARQ feedback message in a slot of a second CC of the plurality of CCs, wherein the slot is based on the determined offset value, and wherein the HARQ feedback message indicates one of an acknowledgement (ACK) or a negative ACK (NACK) for data transmitted by the first network node.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a base station and user equipment (UE) in an access network.

FIG. 4 is a diagram illustrating an example of multiple component carriers (CCs) configured for communication between a network entity and a UE.

FIG. 5 is a call flow diagram illustrating example operations for reporting acknowledgement (ACK)/negative ACK (NACK) feedback in multi-CC configurations.

FIG. 6 is a diagram illustrating example configurations of offset values for aligning ACK/NACK feedback reported on one CC with a slot configuration of another CC.

FIG. 7 is a diagram illustrating other example configurations of offset values for aligning ACK/NACK feedback reported on one CC with a slot configuration of another CC.

FIG. 8 is a flowchart illustrating an example of a method of wireless communication at a UE.

FIG. 9 is a flowchart illustrating an example of a method of wireless communication at a base station.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

In general, this disclosure describes techniques related to attributing values representing offsets between grants and hybrid automatic repeat request (HARQ) feedback on a per-cell or per-carrier basis. That is, a value representing such offsets, such as K1 values, may be allocated on a per-cell or per-carrier basis. In this manner, the values (e.g., K1 values) may be carrier-specific. Accordingly, the techniques of this disclosure may improve the field of wireless communications, especially in the case where network nodes (such as user equipment (UE), base stations, or the like) are configured to participate in multi-carrier wireless communication, in that different carriers can be assigned different offset values (e.g., K1 values). In particular, relatively small sets of K1 indexes can be allocated to different offset values on a per-carrier basis, such that a small set of K1 index values can be mapped to a larger set of slot offsets, according to a carrier-specific mapping of K1 indexes to offset values.

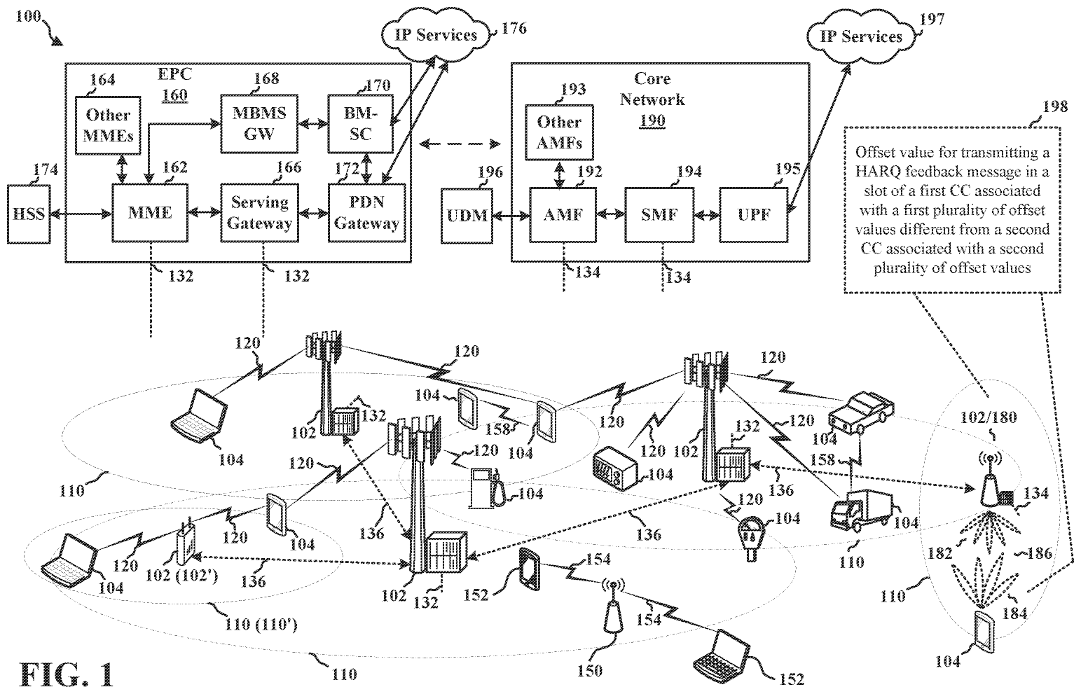

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). In some instances, one or both of base stations and/or UEs 104 may also be referred to as a “network.” The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR), which may be collectively referred to as Next Generation radio access network (RAN) (NG-RAN), may interface with core network 190 through second backhaul links 134. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the base stations 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the base stations 102 may be configured for integrated access and backhaul (IAB). Accordingly, such base stations may wirelessly communicate with other base stations, which also may be configured for IAB.

At least some of the base stations 102 configured for IAB may have a split architecture that includes at least one of a central unit (CU), a distributed unit (DU), a radio unit (RU), a remote radio head (RRH), and/or a remote unit, some or all of which may be collocated or distributed and/or may communicate with one another. In some configurations of such a split architecture, a CU may implement some or all functionality of a radio resource control (RRC) layer, whereas a DU may implement some or all of the functionality of a radio link control (RLC) layer.

Illustratively, some of the base stations 102 configured for IAB may communicate through a respective CU with a DU of an IAB donor node or other parent IAB node (e.g., a base station), and further, may communicate through a respective DU with child IAB nodes (e.g., other base stations) and/or one or more of the UEs 104. One or more of the base stations 102 configured for IAB may be an IAB donor connected through a CU with at least one of the EPC 160 and/or the core network 190. With such a connection to the EPC 160 and/or core network 190, a base station 102 operating as an IAB donor may provide a link to the EPC 160 and/or core network 190 for one or more UEs and/or other IAB nodes, which may be directly or indirectly connected (e.g., separated from an IAB donor by more than one hop) with the IAB donor. In the context of communicating with the EPC 160 or the core network 190, both the UEs and IAB nodes may communicate with a DU of an IAB donor. In some additional aspects, one or more of the base stations 102 may be configured with connectivity in an open RAN (ORAN) and/or a virtualized RAN (VRAN), which may be enabled through at least one respective CU, DU, RU, RRH, and/or remote unit.

The base stations 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the base stations 102 may provide communication coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The base stations 102 and/or UEs 104 may use spectrum up to Y megahertz (MHz) (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a base station at the access network level and to at least one core network entity (e.g., AMF and/or MME) at the core network level, and the UE may be configured to receive downlink control information in the access network (e.g., the UE may be in an RRC Connected state). In some instances in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, the term “sub-6 GHz,” “sub-7 GHz,” and the like, to the extent used herein, may broadly represent frequencies that may be less than 6 GHz, frequencies that may be less than 7 GHz, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A base station 102, whether a small cell 102′ or a large cell (e.g., macro base station), may include and/or be referred to as an eNB, gNodeB (gNB), or another type of base station. Some base stations 180, such as gNBs, may operate in a traditional sub 6 GHz spectrum, in mmW frequencies, and/or near-mmW frequencies in communication with the UE 104. When such a base station 180 (e.g., gNB) operates in mmW or near-mmW frequencies, the base station 180 may be referred to as a mmW base station. The (mmW) base station 180 may utilize beamforming 186 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182. The UE 104 may receive the beamformed signal from the base station 180 in one or more receive directions 184. The UE 104 may also transmit a beamformed signal to the base station 180 in one or more transmit directions. The base station 180 may receive the beamformed signal from the UE 104 in one or more receive directions. One or both of the base station 180 and/or the UE 104 may perform beam training to determine the best receive and/or transmit directions for the one or both of the base station 180 and/or UE 104. The transmit and receive directions for the base station 180 may or may not be the same. The transmit and receive directions for the UE 104 may or may not be the same.

In various different aspects, one or more of the base stations 102/180 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology.

In some aspects, one or more of the base stations 102/180 may be connected to the EPC 160 and may provide respective access points to the EPC 160 for one or more of the UEs 104. The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

In some other aspects, one or more of the base stations 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

As used herein, a network node may refer to any UE, base station, apparatus, device, or computing system configured to perform any techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different. Similarly, reference to a UE, base station, apparatus, device, or computing system may include disclosure of the UE, base station, apparatus, device, or computing system being a network node. For example, disclosure that a UE is configured to receive information from a base station also discloses that a first network node is configured to receive information from a second network node. In this example, consistent with this disclosure, the first network node may refer to a first UE, a first base station, a first apparatus, a first device, or a first computing system configured to receive the information; and the second network node may refer to a second UE, a second base station, a second apparatus, a second device, or a second computing system.

In certain aspects, a first network node (e.g., a base station 102/180 or a UE) may be configured to transmit downlink control information (DCI) to a second network node (e.g., UE 104 or a base station). The DCI may include a scheduling grant for a first CC to be communicated over a channel and a hybrid automatic repeat request (HARQ) feedback offset index value. The channel may be a PDCCH or a PSCCH. The first network node may be further configured to receive, from the second network node, a HARQ feedback message in a slot of a second CC. The slot in which the HARQ feedback message is received may be offset from the slot in which the data to which the HARQ feedback message corresponds by an offset value 198. For example, the slot in which the HARQ feedback message is received may be based on a HARQ feedback offset index value. The HARQ feedback message indicates ACK/NACK feedback for data transmitted by the first network node.

In certain aspects, a first network node (e.g., UE 104 or a base station) may receive DCI from a second network node (e.g., base station 102/180 or a UE) or a third network node (e.g., a base station or a UE). The DCI may include a scheduling grant for a first CC to be communicated over a channel and a HARQ feedback offset index value. The channel may be a PDCCH or a PSCCH. The first network node may determine, based on the HARQ feedback offset index value, an offset value of a first plurality of offset values associated with the first CC. The first network node may transmit a HARQ feedback message in a slot of a second CC that is based on the offset value 198. The HARQ feedback message indicates ACK/NACK feedback for data transmitted by the second network node.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

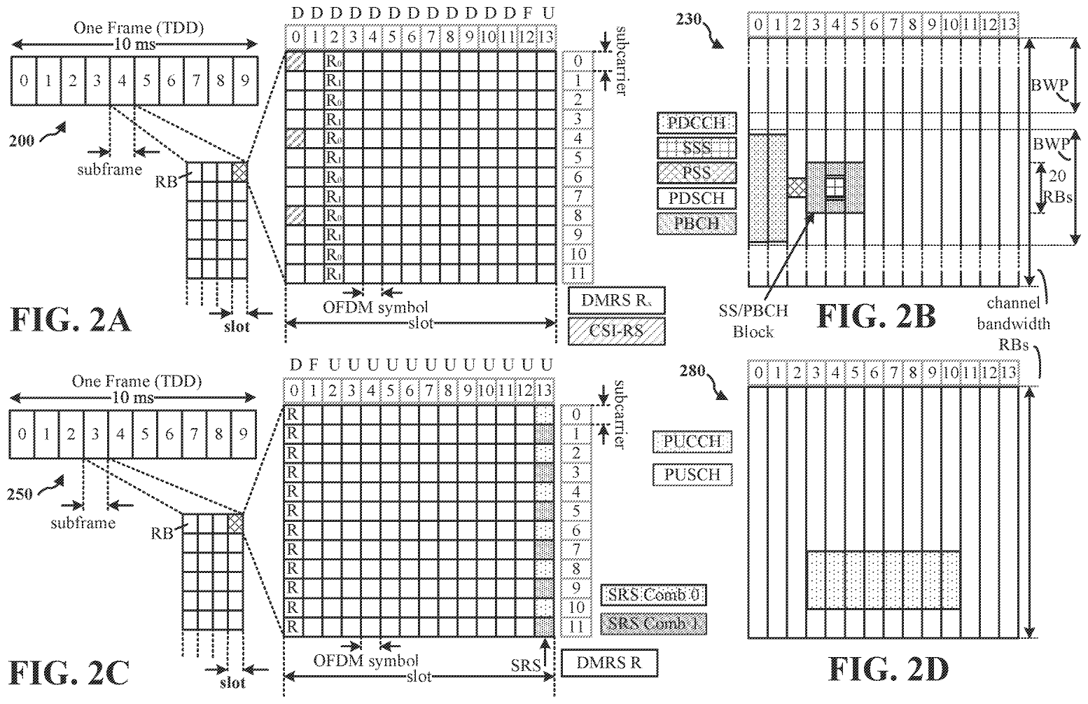

FIG. 2A is a diagram illustrating an example of a first subframe 200 within a 5G NR frame structure. FIG. 2B is a diagram illustrating an example of downlink channels within a 5G NR subframe 230. FIG. 2C is a diagram illustrating an example of a second subframe 250 within a 5G NR frame structure. FIG. 2D is a diagram illustrating an example of uplink channels within a 5G NR subframe 280. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A, 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through DCI, or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe.

The subcarrier spacing (SCS) and symbol length/duration are a function of the numerology. The SCS may be equal to 2^{μ}*15 kilohertz (kHz), where μ is the numerology 0 to 4. As such, the numerology μ=0 has an SCS of 15 kHz and the numerology μ=4 has an SCS of 240 kHz. The symbol length/duration is inversely related to the SCS. FIGS. 2A-2D provide an example of slot configuration 0 with 14 symbols per slot and numerology μ=2 with 4 slots per subframe. The slot duration is 0.25 ms, the SCS is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rx for one particular configuration, where 100× is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

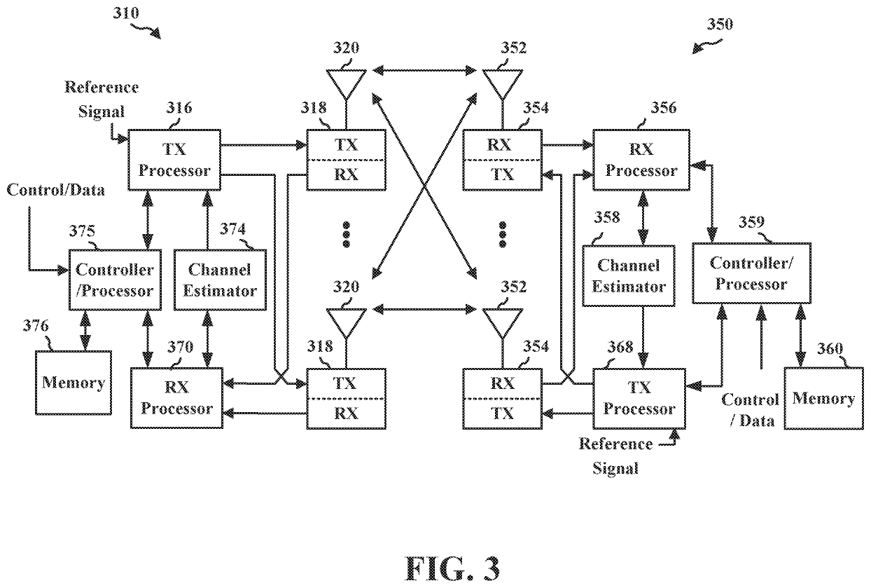

FIG. 3 is a block diagram of a base station 310 in communication with a UE 350 in an access network 300. In the downlink, IP packets from the EPC 160 may be provided to a controller/processor 375. The controller/processor 375 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement Layer 1 (L1) functionality associated with various signal processing functions. L1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through at least one respective antenna 352. Each receiver 354RX recovers information modulated onto an RF carrier and provides the information to the receive (RX) processor 356. The TX processor 368 and the RX processor 356 implement L1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements L3 and L2 functionality.

The controller/processor 359 can be associated with a memory 360 that stores program codes and data. The memory 360 may be referred to as a computer-readable medium. In the uplink, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the downlink transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The uplink transmission is processed at the base station 310 in a manner similar to that described in connection with the receiver function at the UE 350. Each receiver 318RX receives a signal through at least one respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the uplink, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In some configurations, at least one of the TX processor 368, the RX processor 356, and the controller/processor 359 may be configured to perform aspects in connection with the offset value 198 of FIG. 1.

In some other configurations, at least one of the TX processor 316, the RX processor 370, and the controller/processor 375 may be configured to perform aspects in connection with the offset value 198 of FIG. 1.

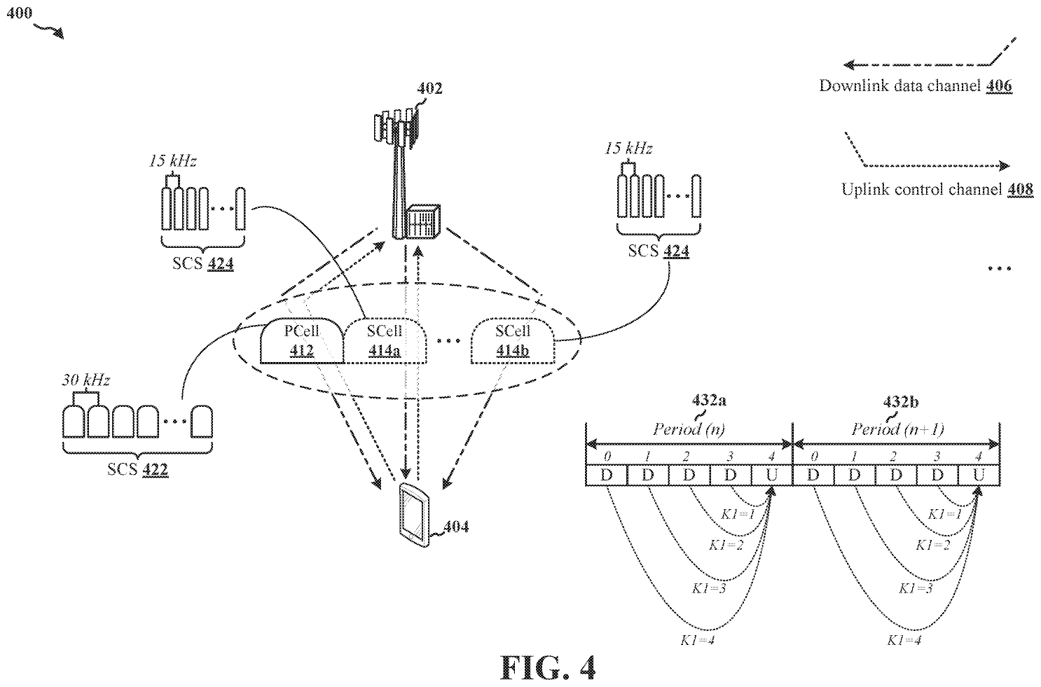

FIG. 4 is a diagram illustrating an example of a wireless communications environment 400 in which multiple CCs are configured for communication between a base station 402 and a UE 404. As illustrated, communication between the UE 404 and a radio access or other wireless network via at least one base station 402 may be configured on cells 412, 414a-414b. For example, carrier aggregation may be used to group together multiple carrier frequencies for the UE 404, which may increase throughput, reliability, and the like.

While the present disclosure describes some concepts and aspects in the context of one base station (or other network entity), the present disclosure contemplates other implementations in which one or more messages and/or other such signaling is communicated with the UE 404 via at least one other base station (e.g., picocell, femto cell, gNB, etc.), e.g., in addition or alternative to the illustrated base station 402. Thus, in some aspects, the “base station 402” may be taken to convey “at least one base station.” Further, while the base station 402 is shown as configuring all of the cells 412, 414a-414b, some or all of the SCells 414a-414b may be operated or controlled by different and/or other network nodes.

In some configurations, the cells 412, 414a-414 configured for communication with the UE 404 may include a PCell 412 and one or more SCells 414a-414b. According to various different aspects, one or more of the cells 412, 414a-414b may be respectively referred to as a CC, or one or more of the cells 412, 414a-414b may include at least one respective CC. In some other configurations, one or more of a primary SCell (PSCell) and/or a special cell (SPCell) may be configured for the UE 404, e.g., in addition or alternative to one or more of the SCells 414a-414b.

The UE 404 may find and connect with the base station 402 on the PCell 412. For example, the UE 404 may perform initial access, synchronization, timing acquisition, and/or other such procedures to connect with the base station 402, for example, via a random access channel (RACH) procedure. Thereafter, the base station 402 may configure one or more SCells 414a-414b for communication with the UE 404.

The base station 402 may “serve” the UE 404 through the PCell 412, for example, upon network attachment or registration by the UE 404 and/or while in certain RRC states. In some configurations, the base station 402 may also serve the UE 404 through some or all of the SCells 414a-414b, such as by transmitting data or control information to the UE 404 on one or more data or control channels that are at least partially configured on the SCells 414a-414b.

While the bandwidths of the PCell 412 and the SCells 414a-414b may be collectively used to serve the UE 404, the PCell 412 and the SCells 414a-414b are separate bands, and consequently, may be differently configured, e.g., in terms of slot configuration and/or numerology. For example, the PCell 412 may be configured with a TDD band, whereas at least one of the SCells 414a-414b may be configured with an FDD band (that is, at least one of the SCells 414a-414b may be configured as a downlink-uplink band pair).

According to some configurations, time-domain structures and/or the relative relationships of time-domain structures of the cells 412, 414a-414b (e.g., the number of slots within a subframe) may be based on slot configurations and/or numerologies. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe.

For each of the cells 412, 414a-414b, a respective SCS and respective symbol length depend upon a numerology associated with that cell. In some aspects, some or all of the SCS 422, 424 may be equal, whereas in some other aspects, the SCSs 422, 424 may be different. While the SCSs are shown as 15 kHz and 30 kHz, other SCSs are possible without departing from the scope of the present disclosure (e.g., 60 kHz, 120 kHz, etc.

An SCS may be equal to 2^{μ}*15 kHz, where μ is the numerology 0 to 4. As such, the numerology μ=0 has an SCS of 15 kHz and the numerology μ=4 has an SCS of 240 kHz. The symbol length is thus inversely related to the SCS.

In the example aspects illustrated by FIG. 4, the PCell 412 may be configured with a numerology of μ=1, and therefore, the SCS 422 of the PCell 412 may be 2¹*15=30 kHz. However, one or more of the SCells 414a-414b may be configured with a numerology of μ=0, and therefore, the SCS 424 of the one or more SCells 414a-414b may be 2¹*15=30 kHz. The inverse relationship between symbol length and SCS may dictate that symbols of the PCell 412 are shorter in length than those of the SCells 414a-414b. Consequently, symbol boundaries in the PCell 412 may not align with symbol boundaries in the SCells 414a-414b.

Conflicts such as mixed numerologies and/or slot configurations may complicate implementations in which multiple cells are assigned to a UE. For example, acquisition of multiple timing synchronizations by the UE across multiple cells may be infeasible or prohibitively expensive when timing boundaries (e.g., slot boundaries) are unaligned across those cells and/or when the timing structures are of different lengths (e.g., different slot lengths). Moreover, the foregoing issues notwithstanding, variations in slot configurations may conflict from the UE perspective. For example, a slot configured to carry a downlink transmission on one of the SCells 414a may overlap in time with another slot configured to carry an uplink transmission on another one of the SCells 414b.

In view of the foregoing, communication with the UE 404 on each of the cells 412, 414a-414b assigned to the UE 404 should ostensibly be confined to the respective cell. In other words, where the UE 404 receives a downlink transmission on the PCell 412, the UE 404 should report HARQ ACK/NACK feedback corresponding to that downlink transmission on the PCell 412. Constraining communication in this manner, however, may cause congestions on some cells while simultaneously wasting resources on other cells.

The present disclosure provides various techniques and solutions for HARQ feedback reporting when a UE transmits HARQ feedback a cell that is different from the one on which the UE received (or expected to receive) the corresponding downlink data (or control information).

In certain configurations, the UE 404 and the base station 402 may have a common understanding of resources on which HARQ feedback is expected. For example, when the base station 402 transmits downlink data in one slot, the UE 404 may transmit HARQ ACK/NACK feedback to the base station 402 on a resource (or set of resources) that is commonly understood by the base station 402 and the UE 404 to correspond to that downlink data. Such a mechanism in which correspondence can be implicitly conveyed may reduce signaling overhead, over-the-air congestion, and so forth. Accurate operation of such a mechanism may be facilitated by a commonly known offset (e.g., K1) the defines a number of slots (e.g., n−1 slots) separating a downlink slot carrying the downlink data from an uplink slot carrying the corresponding uplink HARQ feedback.

Illustratively, in a single cell, the base station 402 may transmit data to the UE 404 on the downlink data channel 406. The UE 404 then transmits a HARQ feedback message to the base station 402 beginning in the next available uplink slot that is offset by K1 slots from the end of the downlink slot that included the corresponding data. Illustratively, if the base station transmits data to the UE in downlink slot 0 of period n, then an offset value of four (4) (e.g., K1=4) would enable the UE 404 to transmit a HARQ feedback message on the uplink control channel 408 in the uplink slot 4 of the same period n. Similarly, if the base station transmits data to the UE in downlink slot 3 of period n, then an offset value of one (1) (e.g., K1=1) would enable the UE 404 to transmit a HARQ feedback message on the uplink control channel 408 in the uplink slot 4 of the same period n.

In instances in which multiple cells are assigned to the UE 404, an offset in one cell may be irreconcilable with another cell when the UE receives data in the one cell but reports HARQ feedback in another cell. Illustratively, if the UE 404 receives downlink data in the PCell 412 having 30 kHz SCS 422, but measures the offset and reports the corresponding HARQ feedback in one of the SCells 424 having a 15 kHz SS, the UE 404 will wait approximately twice as long to report the HARQ feedback than the base station 402 expected to receive the HARQ feedback (because the slot length with 15 kHz SCS 424 is approximately twice as long as the slot length with 30 kHz SCS 422).

Thus, the present disclosure describes various techniques and solutions that facilitate a common understanding between a UE and a base station for offsets (e.g., K1) used to coordinate HARQ feedback reporting. For example, the present disclosure provides for a respective set of offset values to be associated with each of the plurality of cells 412, 414a-414b. Separate sets of offset values for cells 412, 414a-414b may prevent the UE 404 and the base station 402 from using conflicting symbol lengths when counting toward the offset uplink slot in which corresponding HARQ feedback is reported.

In some implementations, offset values (e.g., K1) can be conveyed to UEs over the air interface using a HARQ feedback offset index value. Illustratively, the HARQ feedback offset index value may be a three-bit field (e.g., PDSCH-to-HARQ_feedback timing indicator in DCI formats 1_0, 1_1), the value of which can be used by a UE to find a commonly known offset value without consuming a dramatic amount of resources—e.g., the value of the three-bit field may specify an index in a table (configured via RRC signaling, such as an RRC parameter dl-DataToUL-ACK in a PUCCH-Config message or information element (IE)). A set of allowed offset values indexed by such a three-bit field may be configured for the UE using an RRC IE or other message (e.g., PUCCH-Config) for a BWP of a PCell (or PSCell) or a PUCCH SCell. The offset values signaled to the UE may assume the PCell numerology as the reference—in other words, an offset value is assumed to be a number of slots in the PCell, not the number of slots in an SCell in which data may be received.

If the bits of such a field are expected to index an offset value, however, ambiguity may exist with respect to which of the cells the HARQ feedback offset index value (e.g., the value of a three-bit field alone) is applicable.

On approach to reducing such ambiguity is to increase the size of the field, e.g., from three bits to four bits. For Type 1 codebook construction, a greater number of K1 values may be considered for a UE assigned multiple cells, which may increase codebook size. Consequently, signaling and processing overhead may be increased, which may, in turn, increase latency. Thus, the present disclosure describes various techniques and solutions that may avoid increasing bit widths, avoid increasing codebook sizes, and/or avoid some or all potentially deleterious effects on DCI messages.

For example, the present disclosure provides various aspects in which a set of offset values (e.g., K1) is configured for each cell. In such aspects, the granularity for such sets of offset values may be increased from per BWP/per format/per PCell (or SPCell) to per BWP/per format/per cell of each PUCCH group. Type 1 codebooks may be formed on a per cell basis, and as described herein, a set of K1 values may be configured for a cell to the extent that data carried on resources of that cell is acknowledged via other resources of another cell. The set of K1 values may provide a set of slot indices according to the PCell (or SPCell) numerology. While DCI on a PDCCH triggering HARQ feedback reporting may be independent of the K1 set used for the PDCCH. The K1 set commonly understood by a UE and a base station for HARQ feedback reporting may be chosen based on the cell within which PDSCH reception occurs.

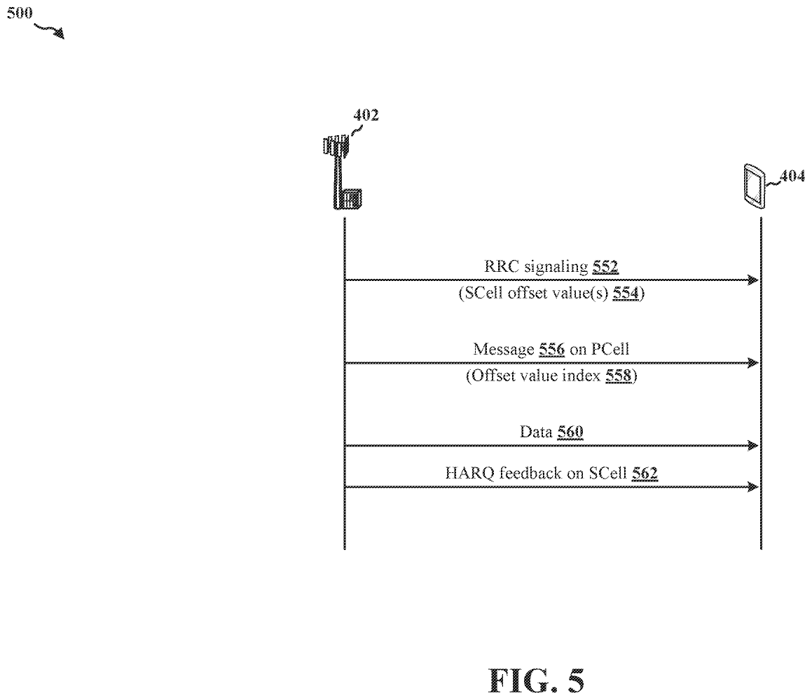

FIG. 5 is a call flow diagram illustrating an example flow of operations 500 for reporting ACK/NACK feedback in multi-CC (or multi-cell) configurations. To configure available offset values for multiple CCs (e.g., PCell, SPCell, PSCell, SCell), the base station 402 may transmit RRC signaling 552 to the UE 404. It will be appreciated that, while the RRC signaling 552 is shown as transmitted from the base station 402, another network node (e.g., another base station) may transmit the RRC signaling 552 to the UE 404 without departing from the scope of the present disclosure.

In some configurations, the RRC signaling 552 may include configuration information associated with a PDSCH on which downlink data is carried through the first CC (e.g., the first SCell 414b). In some other configurations, the RRC signaling 552 may include configuration information associated with a PDCCH on which a HARQ feedback message is carried through the second CC (e.g., the PCell 412). The RRC signaling 552 may include at least a first set of offset values 554 available to be used for HARQ reporting corresponding to data received on a downlink data or shared channel (e.g., PDSCH) through an SCell (e.g., the first SCell 414a).

In some aspects, the RRC signaling 552 may further include a second set of offset values associated with another CC, such as a PCell (e.g., the PCell 412). For example, the RRC signaling 552 may include PDSCH configuration information having the first set of offset values 554 and the second set of offset values, which may be similar to the first set of offset values 554 (some, all, or none of the offset values may differ between the two sets, depending upon the configurations of the cells). In another example, the RRC signaling 552 may include PDCCH configuration information having the first set of offset values 554 and the second set of offset values associated with the first CC (e.g., the first SCell 414a) and the second CC (e.g., the PCell 412), respectively.

In some other aspects, separate RRC signaling (e.g., separate RRC IEs or other messages) may be used to configure first and second sets of offset values for the UE 404. For example, the RRC signaling 552 may include the first set of offset values 554 but may exclude the second set of RRC offset values associated with the second CC (e.g., the PCell 552), or vice versa.

In still other aspects, one or more of the first set of offset values may be configured via RRC signaling (e.g., a first RRC IE or other RRC message), and separately one or more other offset values of the first set of offset values may be configured via separate RRC signaling (e.g., a second RRC IE or second RRC message). In some aspects, the RRC signaling and/or the other RRC signaling may include some or all of the second set of offset values, as well. In some other aspects, the RRC signaling and/or the other RRC signaling may exclude all of the second set of offset values.

Similarly, one or more of the second set of offset values may be configured via RRC signaling (e.g., a first RRC IE or other RRC message), and separately one or more other offset values of the second set of offset values may be configured via separate RRC signaling (e.g., a second RRC IE or second RRC message). In some aspects, one or more of the first set of offset values may be included in such RRC signaling (or separate RRC signaling). In some other aspects, all of the first set of offset values may be excluded from RRC signaling that includes some or all of the second set of offset values.

In some aspects, the UE 404 may receive information indicating one of the first set of offset values or the second set of offset values, but the UE 404 may not be explicitly provided the other of the first set of offset values or the second set of offset values. For example, the first set of offset values may be non-signaled information. Rather, the UE 404 may be configured to determine some or all of the offset values of the other of the first or second set of offset values based on the one of the first or second set of offset values. For example, the UE 404 may be provided the second set of offset values associated with the second CC (e.g., the PCell 412), and the UE 404 may determine (e.g., derive, compute, etc.), one or more of the first set of offset values associated with the first CC (e.g., the first SCell 414a) based on one or more of the second set of offset values.

Illustratively, the UE 404 may apply a rule having an output to the one or more offset values of the second plurality of offset values, and each respective output may be a respective offset value of the first plurality of offset values. In some configurations, the rule includes f(x)=2x+1, and the one or more offset values of the second plurality of offset values are input for x. In some other configurations, the second CC may include a first SCS and the first CC may include a second SCS. In some aspects, the first and second SCSs may be the same, whereas in some other aspects, the first and second SCSs may be different. The abovementioned rule may be based on or may be a function of the first SCS and/or the second SCS.

The output of the rule can be limited to a minimum value or a maximum value. In addition, each respective output of the rule may include a respective invalid value when below the minimum value or above the maximum value, and each respective invalid value can be replaced by a default offset value. For example, the output of the rule may be limited according to the following function ƒ(x)=max(y,min(z,f(x))), where y is the min value, z is the max value and f(x) is some function of x, which may be 2x+1 in some examples as disclosed herein.

Further, the base station 402 (or, in some other aspects, another network node different from the base station 402) may transmit, to the UE 404 a message 556 through the second CC (e.g., the PCell 412). In some aspects, the message 556 may be a DCI message on a PDCCH. In some other aspects, the message 556 may be an RRC IE or other similar RRC message.

The message 556 may include a HARQ feedback offset index value. For example, the HARQ feedback offset index value may be a value in a field (e.g., a three-bit field) that provides an index into the first set of offset values associated with the first CC (e.g., the first SCell 414a). In some aspects, the message 556 may additionally or alternatively include a scheduling grant for a first CC (e.g., the first SCell 414) to be communicated over a channel (e.g., a PUCCH).

Based upon the first set of offset values 554 associated with the first CC (e.g., the first SCell 414a), the UE 404 may determine an offset value of the first plurality of offset values. For example, the UE 404 may access a mapping or other data structure holding the first set of offset values, which may be independently keyed at least in part by based on the HARQ feedback offset index value 558. The UE 404 may identify one of the first set of offset values that corresponds to the HARQ feedback offset index value 558, and the UE 404 may select that identified value. The selected value may be an offset (e.g., K1) to be measured from the end of a slot carrying data.

The base station 402 may transmit data 560 to the UE 404, such as on the first CC (e.g., the first SCell 414a), and the UE may receive and attempt to decode the data 560. Based on receiving and attempting (or succeeding) to decode the data 560, the UE 404 may generate ACK/NACK feedback corresponding to the data 560. For example, the UE 404 may generate an ACK to indicate the data 560 is successfully received and decoded, but the UE 404 may generate a NACK otherwise.

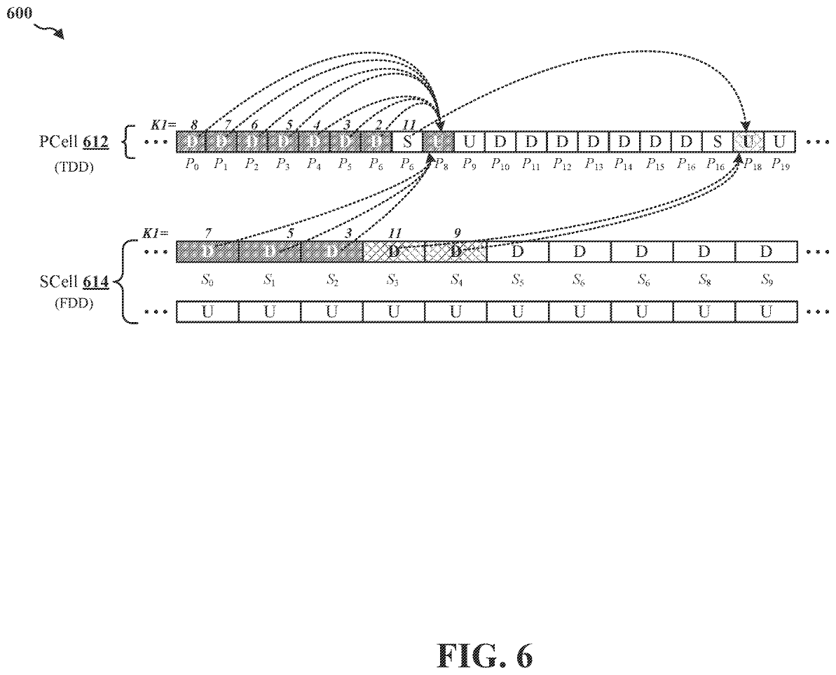

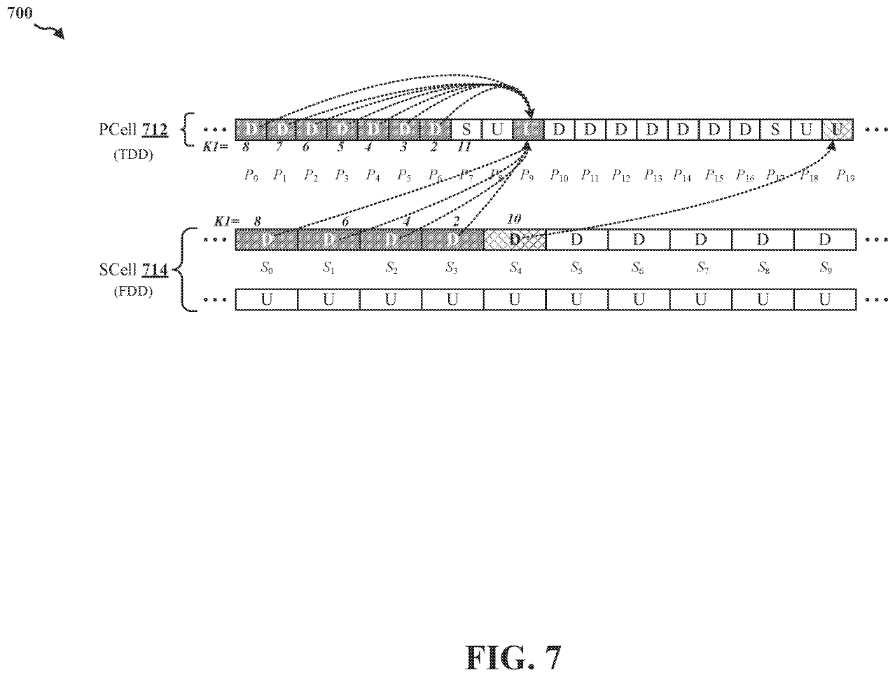

The UE 404 may then use the identified offset value to transmit a HARQ feedback message 562 that indicates the ACK or the NACK corresponding to the data 560. In some aspects, the UE 404 may count from the end of a downlink slot in the second CC (e.g., the PCell) so that the UE attempts to align transmission of the HARQ feedback message 562 with the slot configuration of the second CC (e.g., PCell) and not the first CC. FIGS. 6 and 7 provide some examples of such HARQ feedback message transmission.

FIGS. 6 and 7 provide some examples of such HARQ feedback message transmission in multi-CC configurations. FIGS. 6 and 7 are provided as non-limiting examples only, and other aspects are possible without departing from the scope of the present disclosure.

FIG. 6 is a diagram illustrating example configurations 600 of offset values for aligning ACK/NACK feedback reported on one CC 624 with a slot configuration of another CC 622. In FIG. 6, a UE may be assigned a TDD PCell 612 and an FDD SCell 614, with the PCell 612 having an SCS of 30 kHz and the SCell 614 having an SCS of 15 kHz.

The UE may receive downlink data on a PDSCH through the SCell 614, but may transmit corresponding HARQ feedback on a PUCCH through the PCell 612. In order to keep maintain synchronization and alignment that is commonly understood by the base station (or other network entity) transmitting the data to the UE, the HARQ feedback corresponding to the data received through the SCell 614 may be offset in the context of the PCell 612.

For example, a first set of offset values may be defined for the SCell 614, e.g., such that the available offset values (e.g., K1 values) for the SCell 614 discretely map to a particular uplink slot timing in the PCell 612. In the illustrated example, the slots at times S0, S1, and S2 may be specified as offset values 7, 5, and 3, respectively, so that data received in one of those slots is offset from an available uplink slot in the PCell 612 at P8. However, the downlink slots in the SCell 614 at times S3 and S4 may be too close in time to the uplink slot at time P8 for an offset to occur, and therefore, the offset values that would align HARQ feedback with the slot configuration of the PCell 612 may instead count up to the next available uplink slot occurrence in the PCell 612 at time P18.

In the PCell 612, data received in at times PO through P6 may be respectively given an offset, which may be independent of those offsets enumerated for the SCell 614 or may be configured to facilitate mappings from the SCell slot configuration to the PCell slot configuration.

While mixed numerology may be prohibitive of a one-to-one mapping being slots of the SCell 614 to slots of the PCell 612, the mapping may still enable a commonly known location in the PCell 612 for HARQ feedback corresponding to data received in the SCell 614. Accordingly, HARQ feedback may be transmitted in the PCell 612 even though the data was received in the SCell 614.

Offset values may be tailored to a cell in which the PDSCH occurs. DCI may indicate an offset index and based on the cell for which the grant is provided, a K1 set of offset values may be selected and used to interpret the offset index. For example, the K1 set for the SCell in the previous example could include values {7,5,3,11,9}, while the one for Pcell could include values {8,7,6,5,4,3,2,11}

The DCI that provides a grant in the SCell could use the K1 set associated with the Scell as a reference and pick the feedback delay indicator value as per this set.

Alternately, if the DCI provides a grant in the Pcell, it could use the K1 set associated with the Pcell as a reference and pick the feedback delay indicator value as per this set.

The capability of configuring multiple K1 sets, one per cell, allows some K1 sets to be relatively small while also allowing for seamless flexibility to operate across cells using different numerology. The offset values may occur in one or both a PUCCH-Config or a PDSCH-Config.

FIG. 7 is a diagram illustrating other example configurations 700 of offset values for aligning ACK/NACK feedback reported on one CC 724 with a slot configuration of another CC 722. As shown in FIG. 7, each cell may be associated with an independent set of offset values, e.g., configurable via RRC.

DCI carried by a PDCCH in Pcell may have a grant for the Scell (PDSCH occurs in the Scell). The DCI may have a 3-bit HARQ delay feedback indicator set to 011. The UE may determine that since this DCI brings a grant for the Scell, to interpret the HARQ delay feedback indicator, the K1 offset set associated with Scell is used to interpret this field. Since this field is set to 011, the appropriate offset from Set 2 (above) is chosen by the UE to send ACK.

In some aspects, a UE may use different sets for each cell, but the RRC config only provides one set, and rules may define how to derive the other sets from one set. In an example, this would mean that RRC provides Set 1, and expects the UE to derive Set 2 on its own based on Set 1 and some other rules. For e.g., Set 2 could be derived from Set 1 by taking each value x, and mapping it to 2x+1. The rule could be dependent on two numerologies between the 2 cells. If it exceeds the allowed range then possibly may cap it at max or min value, e.g., 15 to 0 respectively.

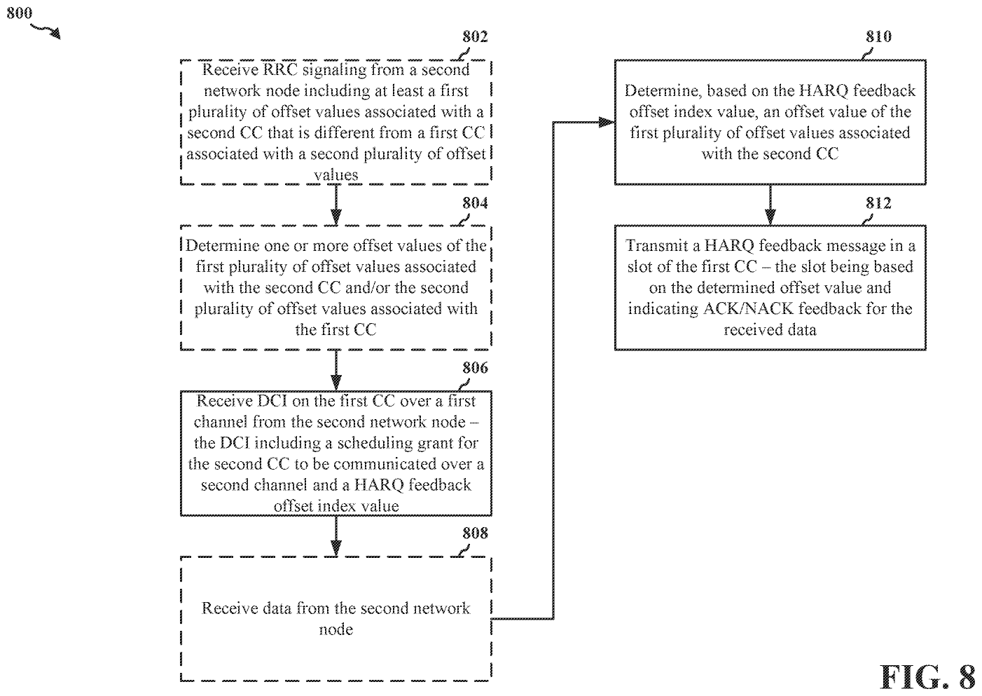

FIG. 8 is a flowchart of a method 800 of wireless communication. The method 800 may be performed by or at a UE (e.g., a UE 104, 350, 404), a network node, another wireless communications apparatus, or one or more components of any of the foregoing. According to various different aspects, one or more of the illustrated blocks may be omitted, transposed, and/or contemporaneously performed.

At 802, the UE may receive RRC signaling from a second network node including at least a first plurality of offset values associated with a second CC that is different from a first CC associated with a second plurality of offset values.

At 804, the UE may determine one or more offset values of the first plurality of offset values associated with the second CC and/or the second plurality of offset values associated with the first CC.

At 806, the UE may receive DCI on the first CC over a first channel from the second network node—the DCI including a scheduling grant for the second CC to be communicated over a second channel and a HARQ feedback offset index value.

At 808, the UE may receive data from the second network node.

At 810, the UE may determine, based on the HARQ feedback offset index value, an offset value of the first plurality of offset values associated with the second CC.

At 812, the UE may transmit a HARQ feedback message in a slot of the first CC—the slot being based on the determined offset value and indicating ACK/NACK feedback for the received data.

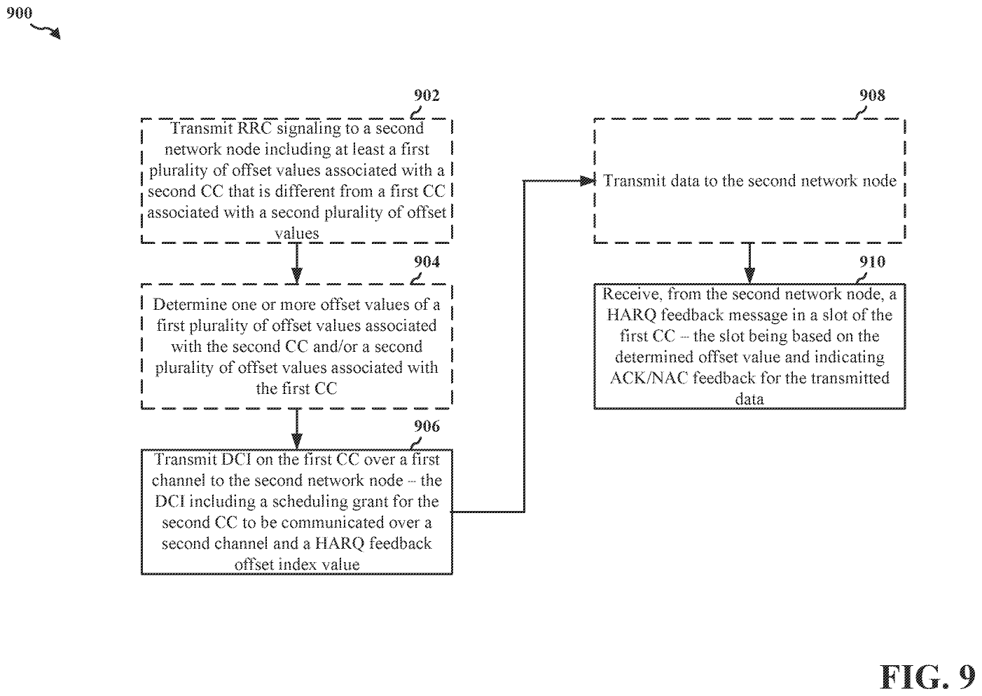

FIG. 9 is a flowchart of a method 900 of wireless communication. The method 900 may be performed by or at a base station (e.g., a base station 102/180, 310, 402), a network node, another wireless communications apparatus, or one or more components of any of the foregoing. According to various different aspects, one or more of the illustrated blocks may be omitted, transposed, and/or contemporaneously performed.

At 902, the base station may transmit RRC signaling to a second network node including at least a first plurality of offset values associated with a second CC that is different from a first CC associated with a second plurality of offset values.

At 904, the base station may determine one or more offset values of a first plurality of offset values associated with the second CC and/or a second plurality of offset values associated with the first CC

At 906, the base station may transmit DCI on the first CC over a first channel to the second network node—the DCI including a scheduling grant for the second CC to be communicated over a second channel and a HARQ feedback offset index value.

At 908, the base station may transmit data to the second network node.

At 910, the base station may receive, the second network node, a HARQ feedback message in a slot of the first CC— the slot being based on the determined offset value and indicating ACK/NAC feedback for the transmitted data.

Various examples of the techniques of this disclosure are summarized in the following clauses:

Clause 1: A method of wireless communication performed by a first network node, comprising: receiving downlink control information (DCI) from a second network node or a third network node, wherein the DCI includes a scheduling grant for a first component carrier (CC) to be communicated over a channel and a hybrid automatic repeat request (HARQ) feedback offset index value; determining, based on the HARQ feedback offset index value, an offset value of a first plurality of offset values associated with the first CC; and transmitting a HARQ feedback message in a slot of a second CC, wherein the slot is based on the determined offset value, and wherein the HARQ feedback message indicates one of an acknowledgement (ACK) or a negative ACK (NACK) for data received from the second network node.

Clause 2: The method of clause 1, wherein the first CC includes a first subcarrier spacing (SCS) and the second CC includes a second SCS, and wherein: the first SCS is greater than the second SCS; the first SCS is less than the second SCS; or the first SCS is equal to the second SCS.

Clause 3: The method of clause 2, wherein: the second CC is at least a part of one of: a primary cell, a primary secondary cell, a special cell, or a physical uplink control channel (PUCCH) secondary cell; and the first CC is at least a part of one of: a secondary cell, a primary secondary cell, a special cell, or a PUCCH secondary cell.

Clause 4: The method of clause 2, wherein the first CC includes a first slot configuration and the second CC includes a second slot configuration, wherein the first slot configuration includes a first time division duplex (TDD) slot configuration or a first frequency division duplex (FDD) slot configuration, and wherein the second slot configuration includes a second TDD slot configuration or a second FDD slot configuration.

Clause 5: The method of clause 1, wherein the HARQ feedback offset index value is represented by less than or equal to six bits.

Clause 6: The method of clause 1, further comprising receiving, from the second network node or the third network node, radio resource control (RRC) signaling, wherein the RRC signaling includes the first plurality of offset values associated with the first CC and a second plurality of offset values associated with the second CC.

Clause 7: The method of clause 6, wherein the RRC signaling includes physical downlink shared channel (PDSCH) configuration information, and wherein the PDSCH configuration information includes the first plurality of offset values and the second plurality of offset values.

Clause 8: The method of clause 6, wherein the RRC signaling includes PUCCH configuration information, and wherein the PUCCH configuration information includes the first plurality of offset values and the second plurality of offset values.

Clause 9: The method of clause 1, further comprising receiving, from the second network node or the third network node, RRC signaling, wherein the RRC signaling includes a second plurality of offset values associated with the second CC, and wherein the RRC signaling excludes one or more offset values of the first plurality of offset values.

Clause 10: The method of clause 9, wherein the RRC signaling includes PDSCH configuration information, and wherein the PDSCH configuration information includes the second plurality of offset values and excludes the first plurality of offset values.

Clause 11: The method of clause 9, wherein the RRC signaling includes PUCCH configuration information, and wherein the PUCCH configuration information includes the second plurality of offset values and excludes the first plurality of offset values.

Clause 12: The method of clause 9, further comprising determining one or more offset values of the first plurality of offset values based on one or more offset values of the second plurality of offset values.

Clause 13: The method of clause 12, wherein determining the one or more offset values of the first plurality of offset values based on the one or more offset values of the second plurality of offset values comprises applying a rule having an output to the one or more offset values of the second plurality of offset values, wherein each respective output is a respective offset value of the first plurality of offset values.

Clause 14: The method of clause 13, wherein the rule includes f(x)=2x+1, wherein the one or more offset values of the second plurality of offset values are input for x.

Clause 15: The method of clause 13, wherein the output of the rule is limited to a minimum value or a maximum value.

Clause 16: The method of clause 15, wherein each respective output of the rule is a respective invalid value when below the minimum value or above the maximum value, and wherein each respective invalid value is replaced by a default offset value.

Clause 17: The method of clause 13, wherein the first CC includes a first subcarrier spacing (SCS) and the second CC includes a second SCS, and wherein the rule is based on the first SCS and the second SCS.

Clause 18: The method of clause 1, wherein the first plurality of offset values is non-signaled information.

Clause 19: The method of clause 1, further comprising receiving, from the second network node or the third network node, RRC signaling, wherein the RRC signaling includes the first plurality of offset values, and wherein the RRC signaling excludes a second plurality of offset values associated with the second CC.

Clause 20: The method of clause 19, wherein the RRC signaling includes PDSCH configuration information, and wherein the PDSCH configuration information includes the first plurality of offset values and excludes the second plurality of offset values.

Clause 21: The method of clause 19, wherein the RRC signaling includes PUCCH configuration information, and wherein the PUCCH configuration information includes the first plurality of offset values and excludes the second plurality of offset values.

Clause 22: The method of clause 19, further comprising determining one or more offset values of the second plurality of offset values based on one or more offset values of the first plurality of offset values.

Clause 23: The method of clause 22, wherein determining the one or more offset values of the second plurality of offset values based on the one or more offset values of the first plurality of offset values comprises applying a rule having an output to the one or more offset values of the first plurality of offset values, wherein each respective output is a respective offset value of the second plurality of offset values.

Clause 24: The method of clause 23, wherein the rule includes f(x)=2x+1, wherein the one or more offset values of the first plurality of offset values is input for x.

Clause 25: The method of clause 23, wherein the output of the rule is limited to a minimum value or a maximum value.

Clause 26: The method of clause 25, wherein each respective output of the rule is a respective invalid value when below the minimum value or above the maximum value, and wherein each respective invalid value is replaced by a default offset value.

Clause 27: The method of clause 23, wherein the second CC includes a first SCS and the first CC includes a second SCS, and wherein the rule is based on the first SCS and the second SCS.

Clause 28: The method of clause 1, wherein the determined offset value represents n−1 slots between the slot of the second CC and a different slot of the second CC, wherein n is the determined offset value.

Clause 29: The method of clause 1, wherein the slot is an nth slot after a different slot of the second CC, wherein n is the determined offset value, wherein at least two slots of the second CC overlap with at least one slot of the first CC, and wherein the different slot is one of the at least two slots.

Clause 30: The method of clause 1, wherein the determined offset value represents n−1 slots between an end of a different slot of the channel and a beginning of the slot, wherein n is the determined offset value.

Clause 31: The method of any of clauses 6-11 and 19-21, wherein second plurality of offset values is dependent on the first plurality of offset values.

Clause 32: The method of any of clauses 6-11 and 19-21, wherein second plurality of offset values is independent from the first plurality of offset values.

Clause 33: A method of wireless communication performed by a first network node, comprising: transmitting downlink control information (DCI) to a second network node, wherein the DCI includes a scheduling grant for a first CC to be communicated over a channel and a hybrid automatic repeat request (HARQ) feedback offset index value; receiving, from the second network node, a HARQ feedback message in a slot of a second CC, wherein the slot is based on the HARQ feedback offset index value, and wherein the HARQ feedback message indicates one of an acknowledgement (ACK) or a negative ACK (NACK) for data transmitted by the first network node.

Clause 34: The method of clause 33, wherein the first CC includes a first subcarrier spacing (SCS) and the second CC includes a second SCS, and wherein: the first SCS is greater than the second SCS; the first SCS is less than the second SCS; or the first SCS is equal to the second SCS.

Clause 35: The method of clause 35, wherein: the second CC is at least a part of one of: a primary cell, a primary secondary cell, a special cell, or a PUCCH secondary cell; and the first CC is at least a part of one of: a secondary cell, a primary secondary cell, a special cell, or a PUCCH secondary cell.

Clause 36: The method of clause 35, wherein the first CC includes a first slot configuration and the second CC includes a second slot configuration, wherein the first slot configuration includes a first time division duplex (TDD) slot configuration or a first frequency division duplex (FDD) slot configuration, and wherein the second slot configuration includes a second TDD slot configuration or a second FDD slot configuration.

Clause 37: The method of clause 33, wherein the HARQ feedback offset index value is represented by less than or equal to six bits.

Clause 38: The method of clause 33, further comprising transmitting, to the second network node, RRC signaling, wherein the RRC signaling includes the first plurality of offset values associated with the first CC and a second plurality of offset values associated with the second CC.

Clause 39: The method of clause 38, wherein the RRC signaling includes PDSCH configuration information, and wherein the PDSCH configuration information includes the first plurality of offset values and the second plurality of offset values.

Clause 40: The method of clause 38, wherein the RRC signaling includes PUCCH configuration information, and wherein the PUCCH configuration information includes the first plurality of offset values and the second plurality of offset values.

Clause 41: The method of clause 33, further comprising transmitting, to the second network node, RRC signaling, wherein the RRC signaling includes a second plurality of offset values associated with the second CC, and wherein the RRC signaling excludes one or more offset values of the first plurality of offset values.

Clause 42: The method of clause 41, wherein the RRC signaling includes PDSCH configuration information, and wherein the PDSCH configuration information includes the second plurality of offset values and excludes the first plurality of offset values.

Clause 43: The method of clause 41, wherein the RRC signaling includes PUCCH configuration information, and wherein the PUCCH configuration information includes the second plurality of offset values and excludes the first plurality of offset values.

Clause 44: The method of clause 33, further comprising receiving, from the second network node, RRC signaling, wherein the RRC signaling includes the first plurality of offset values, and wherein the RRC signaling excludes a second plurality of offset values associated with the second CC.

Clause 45: The method of clause 44, wherein the RRC signaling includes PDSCH configuration information, and wherein the PDSCH configuration information includes the first plurality of offset values and excludes the second plurality of offset values.

Clause 46: The method of clause 44, wherein the RRC signaling includes PUCCH configuration information, and wherein the PUCCH configuration information includes the first plurality of offset values and excludes the second plurality of offset values.

Clause 47: The method of clause 33, wherein n−1 slots are between the slot of the second CC and a different slot of the second CC, wherein n is an integer based on the HARQ feedback offset index value.

Clause 48: The method of clause 33, wherein the slot is an nth slot after a different slot of the second CC, wherein n is an integer based on the HARQ feedback offset index value, wherein at least two slots of the second CC overlap with at least one slot of the first CC, and wherein the different slot is one of the at least two slots.

Clause 49: The method of clause 33, wherein n−1 slots are between an end of a different slot of the channel and a beginning of the slot, wherein n is an integer based on the HARQ feedback offset index value.

Clause 50: The method of any of clauses 38-46, wherein second plurality of offset values is dependent on the first plurality of offset values.

Clause 51: The method of any of clauses 38-46, wherein second plurality of offset values is independent from the first plurality of offset values.

Clause 52: A method comprising one or more techniques described in this disclosure.

Clause 53: A method comprising any combination of clauses 1-52.

Clause 54: An apparatus configured to perform the method of any of clauses 1-53.

Clause 55: The apparatus of clause 54, wherein the apparatus is a processor, a user equipment, a base station, a network node, or a computing system.

Clause 56: An apparatus for wireless communication, comprising: a memory; and one or more processors communicatively coupled with the memory, wherein the one or more processors are configured to perform the method of any of clauses 1-53.

Clause 57: An apparatus comprising one or more means for performing the method of any of clauses 1-53.

Clause 58: The apparatus of clause 57, wherein the one or more means comprise one or more processors.

Clause 59: A non-transitory computer-readable medium comprising code stored thereon that, when executed by an apparatus, causes the apparatus to perform the method of any of clauses 1-53.

Clause 60: A non-transitory computer-readable medium comprising code stored thereon that, when executed by a processor of an apparatus, causes the processor of the apparatus to perform the method of any of clauses 1-53.

Clause 61: A first network node for performing wireless communication via a plurality of component carriers (CCs), the first network node device comprising: a memory configured to store data received via wireless communication; and one or more processors implemented in circuitry and configured to: receive downlink control information (DCI) from a second network node, wherein the DCI includes a scheduling grant for a first component carrier (CC) of the plurality of CCs to be communicated over a channel and a hybrid automatic repeat request (HARQ) feedback offset index value; determine, based on the HARQ feedback offset index value, an offset value of a first plurality of offset values associated with the first CC; and transmit a HARQ feedback message in a slot of a second CC of the plurality of CCs, wherein the slot is based on the determined offset value, and wherein the HARQ feedback message indicates one of an acknowledgement (ACK) or a negative ACK (NACK) for data received from the second network node.

Clause 62: The first network node of clause 61, wherein the first CC includes a first subcarrier spacing (SCS) and the second CC includes a second SCS.

Clause 63: The first network node of clause 62, wherein the first CC includes a first slot configuration including a first time division duplex (TDD) slot configuration or a first frequency division duplex (FDD) slot configuration, and wherein the second CC includes a second slot configuration including a second TDD slot configuration or a second FDD slot configuration.

Clause 64: The first network node of clause 61, wherein the one or more processors are further configured to receive, from the second network node, radio resource control (RRC) signaling, wherein the RRC signaling includes the first plurality of offset values associated with the first CC and a second plurality of offset values associated with the second CC.

Clause 65: The first network node of clause 61, wherein the one or more processors are further configured to receive, from the second network node, radio resource control (RRC) signaling, wherein the RRC signaling includes a second plurality of offset values associated with the second CC, and wherein the RRC signaling excludes one or more offset values of the first plurality of offset values.

Clause 66: The first network node of clause 65, wherein the RRC signaling includes physical downlink shared channel (PDSCH) configuration information including the second plurality of offset values and excluding the first plurality of offset values.

Clause 67: The first network node of clause 65, wherein the RRC signaling includes physical uplink control channel (PUCCH) configuration information including the second plurality of offset values and excluding the first plurality of offset values.

Clause 68: The first network node of clause 65, wherein the one or more processors are further configured to determine one or more offset values of the first plurality of offset values based on one or more offset values of the second plurality of offset values.

Clause 69: The first network node of clause 68, wherein to determine the one or more offset values of the first plurality of offset values, the one or more processors are configured to apply a function having a plurality of possible outputs to the one or more offset values of the second plurality of offset values, wherein each respective output of the plurality of possible outputs corresponds to a respective offset value of the first plurality of offset values.

Clause 70: The first network node of clause 69, wherein the function is f(x)=2x+1, wherein x represents an input to the function, the input including the one or more offset values of the second plurality of offset.

Clause 71: The first network node of clause 69, wherein the one or more processors are configured to: determine whether one of the possible outputs is above a predefined maximum value or below a predefined minimum value; and when the one of the possible outputs is above the predefined maximum value or below the predefined minimum value, replace the one of the possible outputs with a default offset value.

Clause 72: The first network node of clause 61, wherein the one or more processors are further configured to receive, from the second network node, radio resource control (RRC) signaling, wherein the RRC signaling includes the first plurality of offset values, and wherein the RRC signaling excludes a second plurality of offset values associated with the second CC.

Clause 73: The first network node of clause 72, wherein the RRC signaling includes physical downlink shared channel (PDSCH) configuration information including the first plurality of offset values and excluding the second plurality of offset values.

Clause 74: The first network node of clause 72, wherein the RRC signaling includes physical uplink control channel (PUCCH) configuration information including the first plurality of offset values and excluding the second plurality of offset values.

Clause 75: The first network node of clause 72, wherein the one or more processors are further configured to determine one or more offset values of the second plurality of offset values based on one or more offset values of the first plurality of offset values.

Clause 76: The first network node of clause 75, wherein to determine the one or more offset values of the second plurality of offset values, the one or more processors are configured to apply a function having a plurality of possible outputs to the one or more offset values of the first plurality of offset values, wherein each respective output of the plurality of possible outputs is a respective offset value of the second plurality of offset values.

Clause 77: The first network node of clause 76, wherein the function is f(x)=2x+1, wherein x represents an input to the function, the input including the one or more offset values of the first plurality of offset values.

Clause 78: The first network node of clause 76, wherein the one or more processors are further configured to: determine whether one of the possible outputs is above a predefined maximum value or below a predefined minimum value; and when the one of the possible outputs is above the predefined maximum value or below the predefined minimum value, replace the one of the possible outputs with a default offset value.

Clause 79: The first network node of clause 61, wherein the determined offset value represents n−1 slots between the slot of the second CC and a different slot of the second CC, wherein n is an integer value representing the determined offset value.

Clause 80: The first network node of clause 61, wherein the slot is an nth slot after a different slot of the second CC, wherein n is an integer value representing the determined offset value, wherein at least two slots of the second CC overlap with at least one slot of the first CC, and wherein the different slot is one of the at least two slots of the second CC that overlap with the at least one slot of the first CC.

Clause 81: The first network node of clause 61, wherein the determined offset value represents n−1 slots between an end of a different slot of the channel and a beginning of the slot, wherein n is the determined offset value.

Clause 82: A first network node for performing wireless communication via a plurality of component carriers (CCs), the first network node device comprising: a memory configured to store data received via wireless communication; and one or more processors implemented in circuitry and configured to: transmit downlink control information (DCI) to a second network node, wherein the DCI includes a scheduling grant for a first component carrier (CC) of the plurality of CCs to be communicated over a channel and a hybrid automatic repeat request (HARQ) feedback offset index value; and receive, from the second network node, a HARQ feedback message in a slot of a second CC of the plurality of CCs, wherein the slot is based on the determined offset value, and wherein the HARQ feedback message indicates one of an acknowledgement (ACK) or a negative ACK (NACK) for data transmitted by the first network node.

Clause 83: The first network node of clause 82, wherein the first CC includes a first subcarrier spacing (SCS) and the second CC includes a second SCS.

Clause 84: The first network node of clause 83, wherein the first CC includes a first slot configuration including a first time division duplex (TDD) slot configuration or a first frequency division duplex (FDD) slot configuration, and wherein the second CC includes a second slot configuration including a second TDD slot configuration or a second FDD slot configuration.

Clause 85: The first network node of clause 82, wherein the one or more processors are further configured to transmit, to the second network node, radio resource control (RRC) signaling, wherein the RRC signaling includes the first plurality of offset values associated with the first CC and a second plurality of offset values associated with the second CC.

Clause 86: The first network node of clause 85, wherein the RRC signaling includes physical downlink shared channel (PDSCH) configuration information including the second plurality of offset values and excluding the first plurality of offset values.

Clause 87: The first network node of clause 85, wherein the RRC signaling includes physical uplink control channel (PUCCH) configuration information including the second plurality of offset values and excluding the first plurality of offset values.

Clause 88: The first network node of clause 82, wherein the one or more processors are further configured to transmit, to the second network node, radio resource control (RRC) signaling, wherein the RRC signaling includes a second plurality of offset values associated with the second CC, and wherein the RRC signaling excludes one or more offset values of the first plurality of offset values.

Clause 89: The first network node of clause 88, wherein the RRC signaling includes physical downlink shared channel (PDSCH) configuration information including the second plurality of offset values and excluding the first plurality of offset values.

Clause 90: The first network node of clause 88, wherein the RRC signaling includes physical uplink control channel (PUCCH) configuration information including the second plurality of offset values and excluding the first plurality of offset values.

Clause 91: The first network node of clause 82, wherein the one or more processors are further configured to transmit, to the second network node, radio resource control (RRC) signaling, wherein the RRC signaling includes the first plurality of offset values, and wherein the RRC signaling excludes a second plurality of offset values associated with the second CC.

Clause 92: The first network node of clause 91, wherein the RRC signaling includes physical downlink shared channel (PDSCH) configuration information including the second plurality of offset values and excluding the first plurality of offset values.

Clause 93: The first network node of clause 91, wherein the RRC signaling includes physical uplink control channel (PUCCH) configuration information including the second plurality of offset values and excluding the first plurality of offset values.

Clause 94: The first network node of clause 82, wherein n−1 slots are between the slot of the second CC and a different slot of the second CC, wherein n is an integer based on the HARQ feedback offset index value.

Clause 95: The first network node of clause 82, wherein the slot is an nth slot after a different slot of the second CC, wherein n is an integer based on the HARQ feedback offset index value, wherein at least two slots of the second CC overlap with at least one slot of the first CC, and wherein the different slot is one of the at least two slots.

Clause 96: The first network node of clause 82, wherein n−1 slots are between an end of a different slot of the channel and a beginning of the slot, wherein n is an integer based on the HARQ feedback offset index value.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A first network node for wireless communication, the first network node comprising:
a memory; and
one or more processors coupled to the memory, wherein the one or more processors are configured to:
receive downlink control information (DCI), wherein the DCI includes a scheduling grant for a first component carrier (CC) to be communicated over a channel and a hybrid automatic repeat request (HARQ) feedback offset index value;
determine, based on the HARQ feedback offset index value, an offset value of a first plurality of offset values associated with the first CC; and
transmit a HARQ feedback message in a slot of a second CC, wherein
the slot is based on the determined offset value, and wherein the HARQ feedback message indicates one of an acknowledgement (ACK) or a negative ACK (NACK) for data received from a second network node.

2. The first network node of claim 1, wherein the first CC includes a first subcarrier spacing (SCS) and the second CC includes a second SCS.

3. The first network node of claim 2, wherein the first CC includes a first slot configuration including a first time division duplex (TDD) slot configuration or a first frequency division duplex (FDD) slot configuration, and wherein the second CC includes a second slot configuration including a second TDD slot configuration or a second FDD slot configuration.

4. The first network node of claim 1, wherein the one or more processors are further configured to receive, from the second network node, radio resource control (RRC) signaling, wherein the RRC signaling includes the first plurality of offset values associated with the first CC and a second plurality of offset values associated with the second CC.

5. The first network node of claim 1, wherein the one or more processors are further configured to receive, from the second network node, radio resource control (RRC) signaling, wherein the RRC signaling includes a second plurality of offset values associated with the second CC, and wherein the RRC signaling excludes one or more offset values of the first plurality of offset values.

6. The first network node of claim 5, wherein the RRC signaling includes physical downlink shared channel (PDSCH) configuration information including the second plurality of offset values and excluding the first plurality of offset values.

7. The first network node of claim 5, wherein the RRC signaling includes physical uplink control channel (PUCCH) configuration information including the second plurality of offset values and excluding the first plurality of offset values.

8. The first network node of claim 5, wherein the one or more processors are further configured to determine one or more offset values of the first plurality of offset values based on one or more offset values of the second plurality of offset values.

9. The first network node of claim 8, wherein to determine the one or more offset values of the first plurality of offset values, the one or more processors are configured to apply a function having a plurality of possible outputs to the one or more offset values of the second plurality of offset values, wherein each respective output of the plurality of possible outputs corresponds to a respective offset value of the first plurality of offset values.

10. The first network node of claim 9, wherein the function is f(x)=2x+1, wherein x represents an input to the function, the input including the one or more offset values of the second plurality of offset.

11. The first network node of claim 9, wherein the one or more processors are configured to:
determine whether one of the possible outputs is above a predefined maximum value or below a predefined minimum value; and
when the one of the possible outputs is above the predefined maximum value or below the predefined minimum value, replace the one of the possible outputs with a default offset value.

12. The first network node of claim 1, wherein the one or more processors are further configured to receive, from the second network node, radio resource control (RRC) signaling, wherein the RRC signaling includes the first plurality of offset values, and wherein the RRC signaling excludes a second plurality of offset values associated with the second CC.

13. The first network node of claim 12, wherein the RRC signaling includes physical downlink shared channel (PDSCH) configuration information including the first plurality of offset values and excluding the second plurality of offset values.

14. The first network node of claim 12, wherein the RRC signaling includes physical uplink control channel (PUCCH) configuration information including the first plurality of offset values and excluding the second plurality of offset values.

15. The first network node of claim 12, wherein the one or more processors are further configured to determine one or more offset values of the second plurality of offset values based on one or more offset values of the first plurality of offset values.

16. The first network node of claim 15, wherein to determine the one or more offset values of the second plurality of offset values, the one or more processors are configured to apply a function having a plurality of possible outputs to the one or more offset values of the first plurality of offset values, wherein each respective output of the plurality of possible outputs is a respective offset value of the second plurality of offset values.

17. The first network node of claim 16, wherein the function is f(x)=2x+1, wherein x represents an input to the function, the input including the one or more offset values of the first plurality of offset values.

18. The first network node of claim 16, wherein the one or more processors are further configured to:
determine whether one of the possible outputs is above a predefined maximum value or below a predefined minimum value; and
when the one of the possible outputs is above the predefined maximum value or below the predefined minimum value, replace the one of the possible outputs with a default offset value.

19. The first network node of claim 1, wherein the determined offset value represents n−1 slots between the slot of the second CC and a different slot of the second CC, wherein n is an integer value representing the determined offset value.

20. The first network node of claim 1, wherein the slot is an n^{th} slot after a different slot of the second CC, wherein n is an integer value representing the determined offset value, wherein at least two slots of the second CC overlap with at least one slot of the first CC, and wherein the different slot is one of the at least two slots of the second CC that overlap with the at least one slot of the first CC.

21. The first network node of claim 1, wherein the determined offset value represents n−1 slots between an end of a different slot of the channel and a beginning of the slot, wherein n is the determined offset value.

22. A first network node for wireless communication, the first network node comprising:
a memory; and
one or more processors coupled to the memory, wherein the one or more processor are configured to:
transmit downlink control information (DCI) to a second network node, wherein the DCI includes a scheduling grant for a first component carrier (CC) to be communicated over a channel and a hybrid automatic repeat request (HARQ) feedback offset index value; and
receive, from the second network node, a HARQ feedback message in a slot of a second CC, wherein the slot is based on the HARQ feedback offset index value, and wherein the HARQ feedback message indicates one of an acknowledgement (ACK) or a negative ACK (NACK) for data transmitted by the first network node.

23. The first network node of claim 22, wherein the first CC includes a first subcarrier spacing (SCS) and the second CC includes a second SCS.

24. The first network node of claim 23, wherein the first CC includes a first slot configuration including a first time division duplex (TDD) slot configuration or a first frequency division duplex (FDD) slot configuration, and wherein the second CC includes a second slot configuration including a second TDD slot configuration or a second FDD slot configuration.

25. The first network node of claim 22, wherein the one or more processors are further configured to transmit, to the second network node, radio resource control (RRC) signaling, wherein the RRC signaling includes a first plurality of offset values associated with the first CC and a second plurality of offset values associated with the second CC.

26. The first network node of claim 25, wherein the RRC signaling includes physical downlink shared channel (PDSCH) configuration information including the second plurality of offset values and excluding the first plurality of offset values.

27. The first network node of claim 25, wherein the RRC signaling includes physical uplink control channel (PUCCH) configuration information including the second plurality of offset values and excluding the first plurality of offset values.

28. The first network node of claim 22, wherein the one or more processors are further configured to transmit, to the second network node, radio resource control (RRC) signaling, wherein the RRC signaling includes a second plurality of offset values associated with the second CC, and wherein the RRC signaling excludes one or more offset values of the first plurality of offset values.

29. The first network node of claim 28, wherein the RRC signaling includes physical downlink shared channel (PDSCH) configuration information including the second plurality of offset values and excluding the first plurality of offset values.

30. The first network node of claim 28, wherein the RRC signaling includes physical uplink control channel (PUCCH) configuration information including the second plurality of offset values and excluding the first plurality of offset values.

31. The first network node of claim 22, wherein the one or more processors are further configured to transmit, to the second network node, radio resource control (RRC) signaling, wherein the RRC signaling includes the first plurality of offset values, and wherein the RRC signaling excludes a second plurality of offset values associated with the second CC.

32. The first network node of claim 31, wherein the RRC signaling includes physical downlink shared channel (PDSCH) configuration information including the second plurality of offset values and excluding the first plurality of offset values.

33. The first network node of claim 31, wherein the RRC signaling includes physical uplink control channel (PUCCH) configuration information including the second plurality of offset values and excluding the first plurality of offset values.

34. The first network node of claim 22, wherein n−1 slots are between the slot of the second CC and a different slot of the second CC, wherein n is an integer based on the HARQ feedback offset index value.

35. The first network node of claim 22, wherein the slot is an nth slot after a different slot of the second CC, wherein n is an integer based on the HARQ feedback offset index value, wherein at least two slots of the second CC overlap with at least one slot of the first CC, and wherein the different slot is one of the at least two slots.

36. The first network node of claim 22, wherein n−1 slots are between an end of a different slot of the channel and a beginning of the slot, wherein n is an integer based on the HARQ feedback offset index value.
